(19) United States
(12) Patent Application Publication
(10) Pub. No.: US 2009/0187448 A1
(43) Pub. Date: Jul. 23, 2009

(54) Alerts Realtime LLC

(75) Inventors: Joseph John Melfi, Rye, NY (US); Gary Kofman, Aberdeen, NJ (US); Michael Fogarty, Freehold, NJ (US)

Correspondence Address: Joseph Melfi, 40 Rawson Circle, Ocean, NJ, 07712, US

(73) Assignees: Joseph John Melfi, Ocean, NJ (US); Gary Kofman, Aberdeen, NJ (US); Michael John Fogarty, Freehold, NJ (US)

(21) Appl. No.: 12/363,732

(22) Filed: Jan. 31, 2009

(51) Int. Cl. G06Q 10/00; G06Q 50/00

(52) U.S. Cl. 705/7

(57) ABSTRACT

Today, the average Emergency Alert Vendor is limited by their business model and infrastructure capabilities. This market is built around vendors who build capacity for delivery and whose business model is built on recouping their capital investment through charging customers for transactions on their platforms. This model works for consistent monthly recurring revenue but breaks down for large scale emergency users who need a large amount of capacity for a short period of time.

The customer base is not willing to pay a high Capital investment for infrastructure that they will use on demand and the vendors are not willing to make an investment in capacity that they may never be able to recoup their investment on.

Alerts Realtime's business model is focused directly at addressing this business model problem. We have created a platform which leverages many vendors' capital investments and creates one pool of capacity that we manage in Realtime. Our core platform manages our multiple service providers' capacity as one large pool where we route our customers alerts to the appropriate vendor (or multiple vendors) while managing the customers service level in Realtime. Our Delivery Broker manages all of our vendor connections and monitors them in Realtime for congestion and throughput capability during the delivery process to ensure that we can meet or exceed our clients Service Level Agreement (SLA).

### BACKGROUND OF INVENTION

Alerts Realtime, Inc., a New York corporation (“Alerts Realtime”), is a leading provider of innovative on-demand emergency alert services (SMS, Voice and eMail) for large Enterprise customers who need to reach wide audiences in minutes. Alerts Realtime has created a solution that has vastly improved time sensitive delivery capabilities through the creation of its Delivery Broker which is a breakthrough in addressing cost effective and timely delivery that has been a major weakness for this marketplace.
New market demands and government regulatory pressures are merging with a growing paranoia around terrorist activities and college campus takeover incidents.
This has created an atmosphere of immediate need, acceptance and willingness to pay for new technologies with the potential to save lives, decrease stress and minimize the loss of property.
Global events, technology advances and the advent of reaching consumers anytime and anywhere are rapidly reshaping this marketplace.

### BRIEF SUMMARY OF THE INVENTION

Today, the average Software as a Service (SMS) Emergency Alert Vendor is limited by their business model and infrastructure capabilities. This market is built around vendors who build capacity for delivery and whose business model is built on recouping their capital investment through charging customers for transactions on their platforms. This model works for consistent monthly recurring revenue but breaks down for large scale emergency users who need a large amount of capacity for a short period of time.

The customer base is not willing to pay a high Capital investment for infrastructure that they will use on demand and the vendors are not willing to make an investment in capacity that they may never be able to recoup their investment on.

Alerts Realtime's business model is focused directly at addressing this business model problem. We have created a platform which leverages many vendors' capital investments and creates one pool of capacity that we manage in Realtime. Our core platform manages our multiple service providers' capacity as one large pool where we route our customers alerts to the appropriate vendor (or multiple vendors) while managing the customers service level in Realtime. Our Delivery Broker manages all of our vendor connections and monitors them in Realtime for congestion and throughput capability during the delivery process to ensure that we can meet or exceed our clients Service Level Agreement (SLA).

### BRIEF DESCRIPTION OF THE SEVERAL VIEWS OF THE DRAWINGS

Component Descriptions

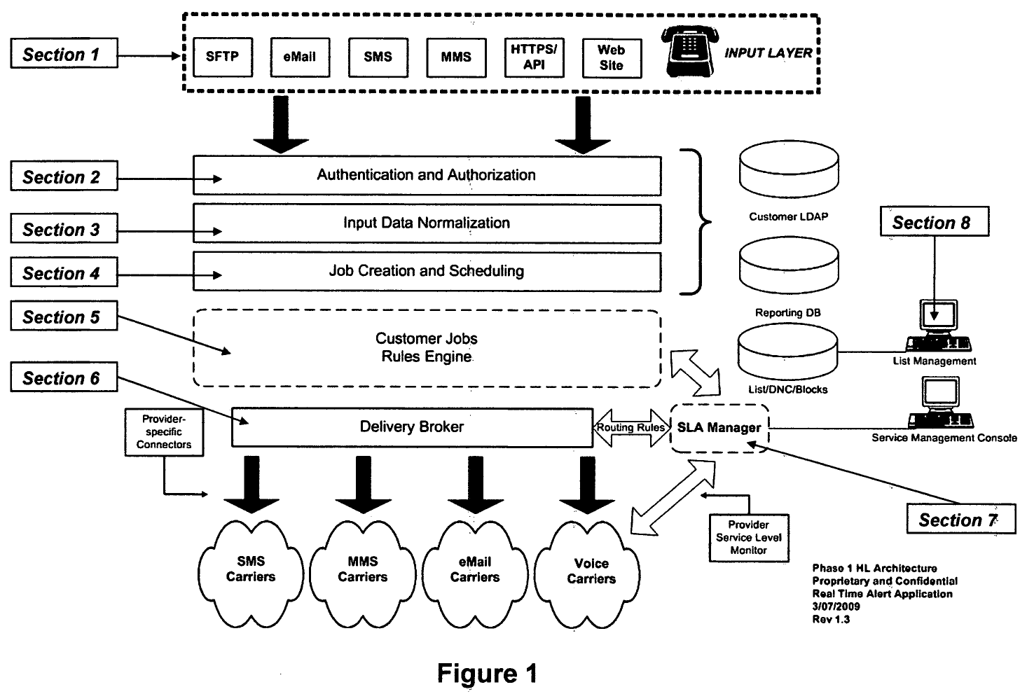

Input Layer (Section 1 in FIG. 1)

These are the components or connectors via which customers submit and manage their jobs.

Secure FTP

Only File Transfer Protocol (FTP) over Secure Sockets Layer (SSL) will be supported. It is expected that FTP will be used by enterprise customers who will choose to interface with the Alerts application from an existing Application Programming Interface (API) interface. It is likely that Secure File Transfer Protocol (SFTP) will be largely used for data upload, modifications and job reporting and other access methods will be used for job launches.

eMail

Both email and email over Transport Layer Security (TLS) will be supported. Based on the recent direction of the market, it is possible that unsecured email will be phased out over the next two years. It is likely that email will be used for data uploads, job launches and reporting.

SMS (Short Message Services)

Both SMS and two way SMS will be supported. It is likely that SMS will be largely used for job launches and two way SMS will be used for both job launches and summary status reports.

MMS (Multimedia Messaging Service)

An emerging technology in US, MMS will be used for submission of multimedia content.

HTTP/API (Hypertext Transfer Protocol/Application Programming Interface)

A web service API will be used for job submission, launch and reporting. The API will support XMS (IBM WebSphere MQ) and be used for enterprise system integration. It is like that this will become the prevailing was of programmatic job control and reporting due to the flexibility inherent in Web Services communications.

Web

The web site will be central user control point for both enterprise and non-enterprise users. It will support:
Job Control
List Management
Job status
Billing
Others

Phone

The phone will be used for emergency job launch only and will be a valuable tool for users who do not have functioning access to the Internet or SMS services. This will be a simple service that will allow a user to enter their ID, password and then choose a preconfigured list for immediate or scheduled delivery.

Authentication and Authorization Layer (Section 2 in FIG. 1)

The authentication and authorization layer provides secure login to the available services. It also establishes user identity and credentials within the application.

Although the access methods are varied, the approach is consistent. Each user on the system will be required to have up to four identity credentials to take advantage of the complete suite of service offerings.
User ID—credentials used for web site, SFTP and HTTPS/API access
User Password—strong complexity
Predefined ANI (Automatic Number Identification)—used for emergency phone access only
Predefined PIN (personal identification number)—used for emergency phone access only.

The credentials will be maintained in a secure, encrypted customer database.

The credentials will also establish access to the customer's recipient lists, job reports and other activity management tools.

Input Data Normalization (Section 3 in FIG. 1)

It is expected that customer data will differ from customer to customer and will need to be normalized and transformed so that the Alerts Application can manage, store and secure it efficiently.
The data will be stored and managed in a common, cost effective, scalable manner.
The data will be prepared for the Job Creation process so that it can be delivered to the carriers in an efficient manner.
The data will be prepared for consistent reporting.

Job Creation and Scheduling (Section 4 in FIG. 1)

This module consists of a number of discreet components.

Job Setup Engine

The Job Setup Engine collects all the information from the customer that is required to setup a job. It interacts with Rules Engine to identify the delivery options. Once it determines what modality or modalities the job consists of, it works with the transformations engine to transform the job information to be specific to the carriers' XML. Once the job is set up, the information gets written to the job database and the Job Scheduler sets up the delivery parameters. The job database will track the specifics of each job, including which carrier the job went to. The Job setup engine will also inform the user with a job number from our system.

Transformation Engine

The transformation engine is responsible for converting the standard Alerts format into carrier and modality specific data format.

Job Scheduler

The Job scheduler will schedule the job based on customer input. If the job is set to deliver immediately it hands the job to Delivery Broker.

Job Tracker

The Job Tracker keeps track of each job by working with the Delivery Broker. It queries the vendor and updates the job status.

Customer Jobs Rules Engine (Section 5 in FIG. 1)

The Rules Engine is a rapid instruction generation mechanism. It produces rules based on client configuration, input from the Service Level Agreement (SLA) Manager and the Delivery Broker. The recipient of the instructions is the Delivery Broker which gets specific instructions on job delivery.

The role of the Rules Engine in phase 1 is fairly minor. It will get significantly more use in Phases 2 and 3 when geocentric functionality is deployed.

Input from Job Creator and Scheduler

The Rules Engine will get the following information
1) Specification of the priority or severity of a job
2) Specification of the schedule of the job
3) Specification of the delivery process, for example first try SMS, then voice

Input from the SLA Manager

The Rules Engine will get the following information
1) Feedback on failed deliveries that require the activation of a backup delivery plan and a reissuance of instructions to the delivery manager

Input from the Geo-Location Module

TBD

Output to the Delivery Broker
1) Deliver message to this number, SMS or MMS address. Provide job receipt, but no confirmation.
2) Deliver message to this number, SMS or MMS address. Provide delivery receipt.
3) Deliver message to this number, SMS or MMS address. Provide delivery receipt. If the delivery is not successful, then report to the Rules Engine for alternate delivery instructions.

Delivery Broker (Section 6 in FIG. 1)

The Delivery Broker is the heart of the platform and the core of what differentiates our business model from the rest of the industry.

The Delivery Broker interfaces with the Customer Rules Engine and the Service Manager to determine the optimum delivery paths for the alert.

The Service Manager provides the Delivery Broker with real-time route information, specifying which carrier is fastest, most reliable and least expensive at a specific time for a specific modality. The more carrier choices the Delivery Broker has, the better the odds of successfully delivering a message are. The Delivery Broker does not establish the Service Levels on its own, it relies on the Service Manager for that information.

The Delivery Broker receives the routing information as a static table and caches it in memory as this offers the highest performance in Delivery Broker following the routing instructions.

The Rules Engine provides the Delivery Broker with specific instructions on delivering a job. Again the intent is for the Delivery Broker to simply follow directions, not do too much thinking as thinking will tend to slow it down.

The Delivery Broker is also managing the carrier connections, turning them off or on and reporting status to the service level manager for deliveries that may have problems completing.

The Delivery Broker will have four responsibilities:

Delivery Process
1. It will receive the correctly formatted and addressed alert from the upstream process.
2. It will initiate the message delivery session to the carrier.
3. It will determine the successful completion of the deliveries.
4. It will determine the failed or out of SLA deliveries.

Delivery Management
1. It will validate the latest route table received from the SM and determine validity before refreshing.
2. It will report on the failed or out of SLA deliveries.
3. It will be able switch to alternate carriers based on failed Service Levels and predefined route tables.
4. It will report the failed Service Levels to the SM so that decisions can be made regarding potential route changes.
5. It will be able to decide on terminating the “hanging” or “pending” deliveries and provide a command to the upstream process to initiate an alternate delivery plan.

Job Completion and Reporting
1. It will update the reports database on the status of the deliveries.
2. It will report failed deliveries to the reports database.

SLA Manager Updates
1. It will report failed deliveries to the SLA Manager

SLA Manager (Section 7 in FIG. 1)

The SLA Manager is responsible for generating the routing table used by the Delivery broker to parse out jobs to the carriers. It generates the table by gathering input from a number of sources.

Gathering Carrier Performance Information

The Service Manager sends synthetic transactions to each carrier every 5 minutes to gauge the performance of each carrier. The following criteria are judged:
1) Carrier's ability to accept and acknowledge a job.
2) Time to attempt a delivery
3) Confirmations of a successful delivery
4) Success Rate for the last 10 minutes

Because the synthetic transaction tests are limited, the Service Manager also gets Quality of Service feedback from the Delivery Broker.

The possible information segments are:
1) Failed deliveries through a specific carrier
2) Failed deliveries of a specific modality
3) Failed deliveries to a specific destination, area code, email address
4) Percentage or number of deliveries that do not satisfy a pre-determined SLA

The SLA Manager will take this information and based on defined routines, update the route tables.

Generating Route Tables

The route table is simple and straight forward. Complex routing algorithms will slow down job routing and cause Service Level exceptions. The following is a tentative prototype.

| Carrier | Value | Effective Value |
|---|---|---|
| Carrier1 Cost | 2 | 1.5 |
| Carrier1 Quality | 1 | |
| Carrier2 Cost | 4 | 4.5 |
| Carrier2 Quality | 5 | |
| Carrier3 Cost | 3 | 3 |
| Carrier3 Quality | 3 | |
| Carrier4 Cost | 5 | 5 |
| Carrier4 Quality | 5 | |

The final design is TBD, but will address the following concepts:
1) Lowest cost path for modality
2) Best quality path for modality
3) Carrier blocked
4) Percentage based routing, i.e. 75% of traffic goes to carrierl, the rest follow normal route

List Management (Section 8 in FIG. 1)

Secure List Management functionality will be implemented.

### DETAILED DESCRIPTION OF THE INVENTION

In addition to the comments above, the Delivery Broker (a.k.a. DVRB) is the heart of the platform and the core of what differentiates our business model from the rest of the industry. The delivery broker will take data from our input agents that will authenticate users and build lists with assigned priority to modality types (SMS, Voice or eMail) based on pre-defined event types and time of day/day of the week.

The delivery broker will have three core processes running:

1. Vendor Management (a.k.a. VDM)

VDM will monitor all vendor connections to the DRVB and run synthetic transactions through their platforms. These proactive transactions will manage latency and deliverability in Realtime. It will keep a live routing table which it will use to make its vendor delivery choices based on job size and modality choice of job or a subset of a job. It will switch vendors in Realtime in the event that the delivery is not possible based upon the assigned SLA.

2. Delivery Process (a.k.a. DLP)

DLP will parse jobs and submit them to chosen vendors and track job progress. This process monitors jobs in Realtime while scrubbing them up against the associated SLA. It will cancel “jobs in progress” in Realtime and chose a secondary or tertiary vendor.

3. Job Completion and Reporting (a.k.a. JCR)

JCR will acknowledge job completion against the customer SLA and pass the data along to the reporting engine within the platform.

1. The Alerts Realtime Business Model represents a major improvement in the capability of the existing emergency alert industry.

2. The Alerts Realtime Business Model represents a major improvement in the efficiency of the use of invested capital and infrastructure of the global messaging industry by developing a mechanism for very high volume emergency alert services.

3. The Alerts Realtime Business model facilitates the delivery of very high volume, emergency alert services at Service Levels not available in the current messaging marketplace by leveraging the entire messaging marketplace as a single pool of capacity.

4. The Alerts Realtime Business Model proprietary concept is to route the emergency alerts across a wide, diverse complement of SMS, MMS, voice, data, and email messaging service providers.

5. The Alerts Realtime Business Model provides for management of Service Levels of the emergency alerts, an ability to determine the quality of underlying providers and the ability to deliver alerts through alternate service providers and modalities in case of infrastructure faults.
